(19) United States
(12) Patent Application Publication
(10) Pub. No.: US 2021/0129747 A1
(43) Pub. Date: May 6, 2021

(54) WORK VEHICLE WITH CORNER ROOF LIGHTS

(71) Applicant: CNH Industrial America LLC, New Holland, PA (US)

(72) Inventors: Jeffrey A. Roeber, West Fargo, ND (US); Edwin Eisenbeisz, West Fargo, ND (US); Dana Froemming, Fargo, ND (US); Tyler Kogler, Fargo, ND (US)

(73) Assignee: CNH Industrial America LLC, New Holland, PA (US)

(21) Appl. No.: 16/670,444

(22) Filed: Oct. 31, 2019

(51) Int. Cl. B60Q 1/46; B60Q 1/26; B60Q 1/00; B60R 16/02

(52) U.S. Cl. CPC B60Q 1/46; B60Q 1/2611; B60Q 1/2696; B62D 25/06; B60R 16/0215; B60Q 1/0088; B60Q 1/0041

(57) ABSTRACT

A warning light system for a work vehicle including a plurality of lighting devices configured for being connected to the roof of the work vehicle and located underneath the plane of the top surface of the roof. At least two lighting devices of the plurality of lighting devices are configured for being visible at any side of the work vehicle. The warning light system also includes a wiring harness configured for operably connecting the plurality of lighting devices to the electrical power source.

### BACKGROUND OF THE INVENTION

The present invention pertains to work vehicles and, more specifically, to warning lights which are mounted on work vehicles.

Work vehicles, such as large construction or agricultural vehicles, generally include a chassis, wheels or tracks for supporting the chassis, a cab for housing the operator, and a prime mover. Some earth-moving work vehicles, such as wheel loaders or backhoes, may additionally include a bucket for carrying a payload.

To meet certain visibility standards and regulations, the work vehicle may be required to have a warning light or beacon which visually warns surrounding vehicular or pedestrian traffic of the location of the work vehicle. The beacon may be required to be visible by traffic from every angle, 360 degrees around the work vehicle. In compliance thereof, numerous construction work vehicles include a rotary beacon that is mounted onto an elevated mast or pedestal which extends above the roof top of the cab. A typical rotary beacon includes a single lamp with a rotary reflector which is protected within a plastic dome cover. The rotary reflector may be rotated by an electric motor, which is operably connected to the electrical system of the work vehicle. The reflector accordingly directs the rays of the lamp in a circular pattern. Other rotary beacons may include a series of light emitting diodes (LEDs) that are sequentially illuminated via firmware for providing the illusion of a circular pattern.

The elevated height of the beacon above the cab, which advantageously increases visibility, may however impose undesired consequences. For example, the elevated beacon negatively impacts the height clearance of the work vehicle. Thereby, the beacon may be required to be removed or folded down during transport of the work vehicle to meet certain roadway height clearances, e.g. bridge clearances. Additionally, the beacon may be damaged by tree branches, doorways, or other low-hanging objects during operation of the work vehicle. Furthermore, the electrical wiring of the beacon, which is typically a flexible power cord, may also become damaged or unplugged upon contacting vegetation or another object.

What is needed in the art is a cost-effective and reliable warning light system for a work vehicle.

### SUMMARY OF THE INVENTION

In one exemplary embodiment formed in accordance with the present invention, there is provided a warning light system for a work vehicle. The warning light system includes strobe lights which are located underneath the roof of the work vehicle and an electrical wiring harness. The strobe lights provide 360-degree visibility such that at least two strobe lights are visible at any side of the work vehicle. The strobe lights eliminate the need for a rotatory beacon, which requires an elevated mounting device.

In another exemplary embodiment formed in accordance with the present invention, there is provided a warning light system for a work vehicle. The work vehicle includes a cab and an electrical power source. The cab includes a roof with a top surface defining a plane. The warning light system includes a plurality of lighting devices configured for being connected to the roof and located underneath the plane of the top surface of the roof. At least two lighting devices of the plurality of lighting devices are configured for being visible at any side of the work vehicle. The warning light system also includes a wiring harness configured for operably connecting the plurality of lighting devices to the electrical power source.

In yet another exemplary embodiment formed in accordance with the present invention, there is provided a work vehicle that includes a chassis, an electrical power source supported by the chassis, and a cab connected to the chassis. The cab includes a roof with a top surface defining a plane. The work vehicle also includes a warning light system that includes a plurality of lighting devices connected to the roof and located underneath the plane of the top surface of the roof. At least two lighting devices of the plurality of lighting devices are configured for being visible at any side of the work vehicle. The warning light system also includes a wiring harness which operably connects the plurality of lighting devices to the electrical power source.

One possible advantage of the exemplary embodiment of the warning light system is that a visual warning to an individual is sufficiently provided without negatively impacting the height clearance of the work vehicle.

Another possible advantage of the exemplary embodiment of the warning light system is that the lighting devices are located underneath and protected by the roof of the work vehicle so that the lighting devices can be fixedly attached to the roof without concern of damage thereto during operation or transport of the work vehicle.

Yet another possible advantage of the exemplary embodiment of the warning light system is that the lighting devices do not negatively impact the operator, for example the lighting devices do not dazzle the eyes of the operator.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a perspective view of an exemplary embodiment of a work vehicle comprising a cab and a warning light system, in accordance with an exemplary embodiment of the present invention;

FIG. 2 illustrates a side view of the work vehicle of FIG. 1;

FIG. 3 illustrates a perspective view of the underside of the roof of the cab of FIG. 1 without the roof cap portion;

FIG. 4 illustrates a front perspective view of a light of the warning light system; and

FIG. 5 illustrates a rear perspective view of the light of FIG. 4.

### DETAILED DESCRIPTION OF THE INVENTION

The terms “forward”, “rearward”, “left” and “right”, when used in connection with the work vehicle and/or components thereof are usually determined with reference to the direction of forward operative travel of the work vehicle, but they should not be construed as limiting. The terms “longitudinal” and “transverse” are determined with reference to the fore-and-aft direction of the work vehicle and are equally not to be construed as limiting.

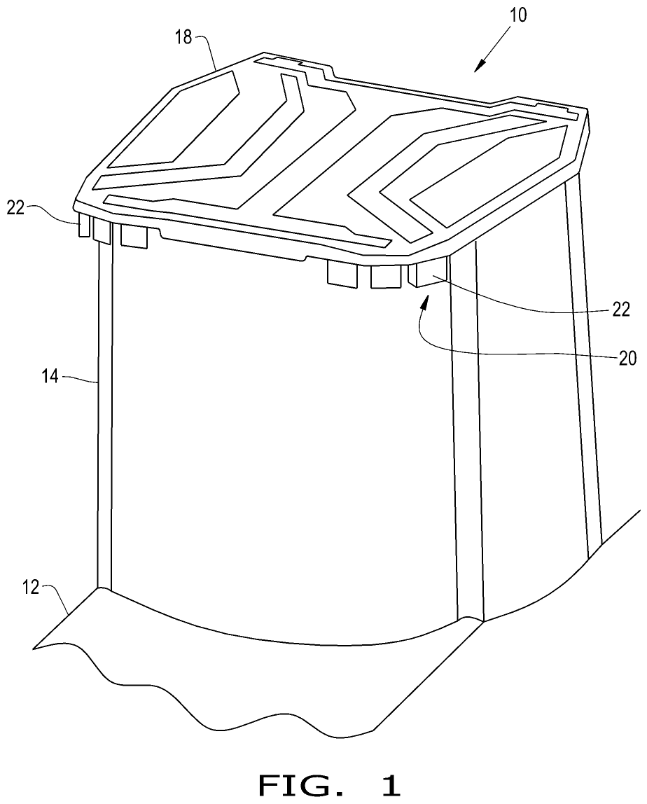

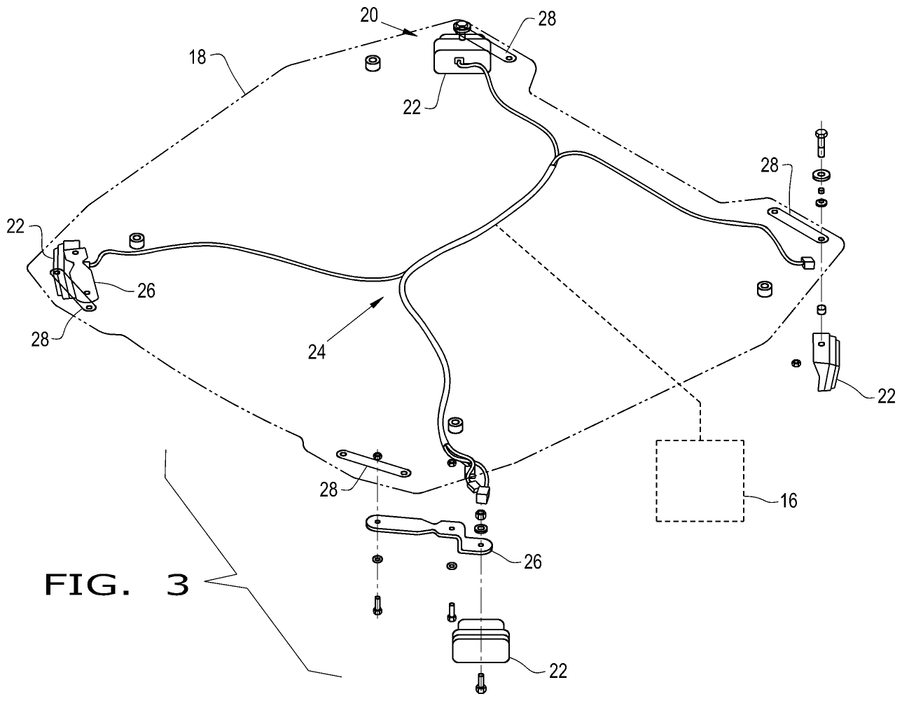

Referring now to the drawings, and more particularly to FIGS. 1-3, there is shown a work vehicle 10 which generally includes a chassis 12, wheels or tracks, a prime mover, a cab 14 for housing an operator, and various tools with accompanying hydraulic and/or electric lines. For instance, the work vehicle 10 may include an electrical power source 16 with accompanying electrical wiring (FIG. 3). The work vehicle 10 may also include a warning light system 20 connected to a roof 18 of the cab 14 and operably connected to the electrical power source 16. As can be appreciated, the work vehicle 10 may be in the form of any desired vehicle. For example, the work vehicle 10 may be in the form of a wheel loader, a backhoe, a skid-steer, a tractor, or a combine.

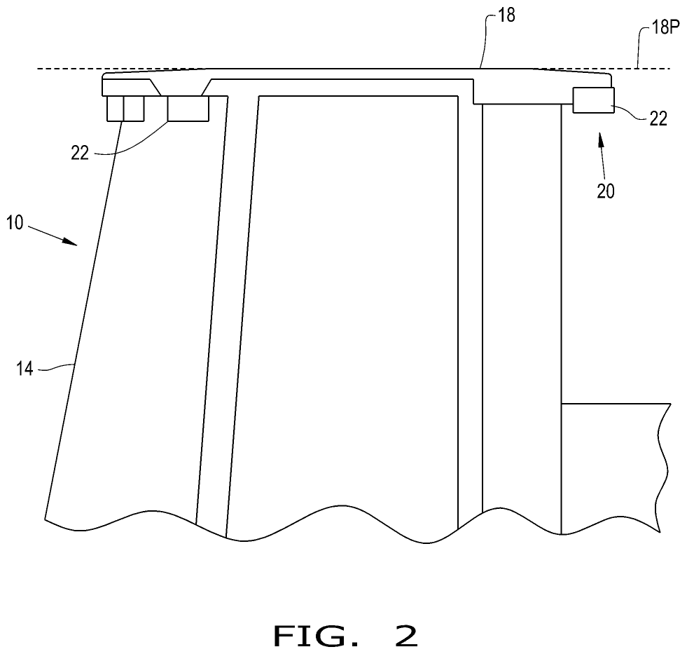

The cab 14 may be comprised of the roof 18, a subframe, a front windshield, a door, and one or more side panels (unnumbered). The roof 18 may be a single-body or multipart component. For example, the roof 18 may include a roof portion and a roof cap portion (unnumbered). The roof 18 has an underside which may be interior to the cab 14, a topside which may be exterior to the cab 14, and four corners. The roof 18, e.g. the topside of the roof cap portion, may have a top surface that defines a plane 18P (FIG. 2). The roof 18 may have one or more through holes for receiving fasteners to mount the warning light system 20. The through holes may be covered and/or sealed by roof cap portions. The roof 18 may comprise any desired material, such as a metal, plastic, and/or fibrous material. The roof 18 may have any desired shape and size.

The electrical power source 16 may be connected to and supported by the chassis 12. The electrical power source 16 may be in the form of any desired electrical power source known in the art. The electrical power source 16 may provide a continuous 12 or 24V DC current.

The warning light system 20 is connected to and supported by the roof 18 of the cab 14. The warning light system 20 generally includes one or more lighting devices 22 located underneath the plane 18P of the roof 18 and an electrical wiring harness 24 that operably connects the lighting devices 22 to the electrical power source 16 (FIG. 3). The warning light system 20 may also include a respective bracket 26, 28 for mounting each lighting device 22 to the roof 18.

The warning light system 20 provides a visual warning which complies with various regulatory requirements without elevating the lighting devices 22 above the roof 18. The warning light system 20 provides 360 degrees of visibility such that an individual, for example a pedestrian or other vehicle operator, will see at least two lighting devices 22 at any side of the work vehicle 10, i.e., any approach angle 360 degrees around the work vehicle 10. In other words, the warning light system 20 provides a cone of visibility all around the work vehicle 10, extending from the cab 14 to the ground. The radius of the cone of visibility may extend 20 meters (65 feet) away from the work vehicle 10. As can be appreciated, the warning light system 20 does not require an elevated mounting device for mounting the lighting devices 22 above the roof 18; and thereby, the warning light system 20 reduces the height clearance required for the work vehicle 10 and decreases the chances that the lights may be damaged by various objects which contact and/or pass over the roof 18.

The lighting devices 22 are mounted to the roof 18 by the brackets 26, 28 and fasteners. More particularly, each lighting device 22 is located adjacent to a respective corner of the roof 18. As shown, each lighting device 22 is located underneath and angled relative to each corner of the roof 18, underneath the cap portion of the roof 18. Since the lighting devices 22 are located underneath the plane 18P of the roof 18, the lighting devices 22 do not need to be removed from the roof 18 or pivoted downwardly for transport. Hence, the lighting devices 22 can be permanently and unmovably connected to the roof 18. The top of the lighting devices 22 may be positioned 5-13 centimeters (2-5 inches) below the plane 18P of the roof 18. However, the lighting devices 22 may be located on the roof 18 at any desired location. It should be appreciated that the lighting devices 22 may be coupled to the roof 18 by way of bolts and/or screws, welds, snap-fitted connections, ball and socket connectors, hook and loop fasteners, etc. For instance, the roof 18 may include recesses and the lights may be press-fitted therein. It is conceivable to mount the lighting devices 22 on the roof 18 such that the top of the lighting devices 22 are flush with the roof 18, e.g. reside within the plane 18P. It is also conceivable to mount at least a portion of the lighting devices 22 above the roof plane 18P. Furthermore, the lighting devices 22 may be mounted on the subframe of the cab 14. Additionally or alternatively, the lighting devices 22 may also be located at a different location other than the roof 18. For example, the lighting devices 22 may be located on a different section of the chassis 12, e.g. near a tallest point or rear section of the chassis 12, a towed implement, trailer, tank, etc., or on any other desired portion of the work vehicle 10, such as a hopper or tank of an agricultural vehicle. As can be appreciated, the warning light system 20 may include any number of lighting devices 22, such as two, four, or more lighting devices 22.

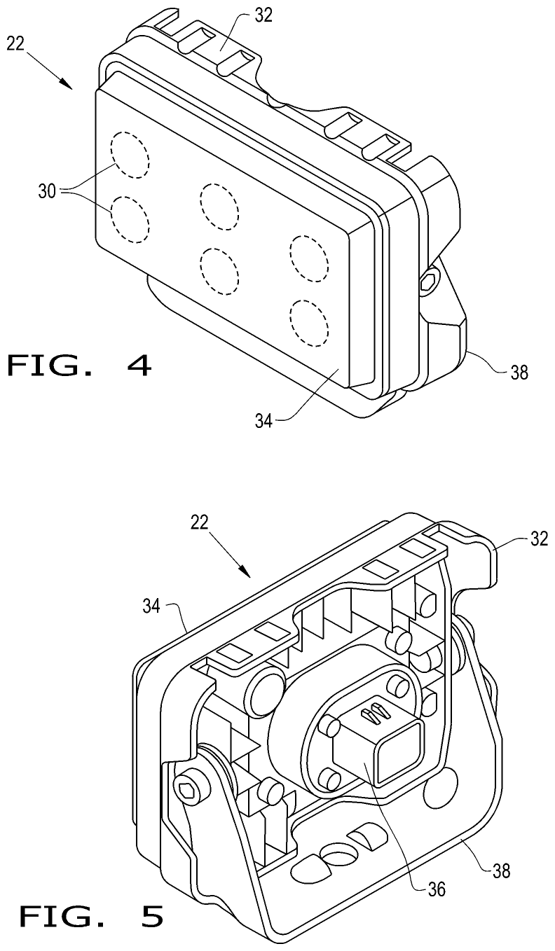

Referring now collectively to FIGS. 1-5, there is shown a lighting device 22 in further detail. Each lighting device 22 can be in the form of a strobe light 22. Each strobe light 22 generally includes an array of light emitting diodes (LEDs) 30, a body 32, a window case 34 connected to the body 32 for covering the LEDs 30, and a built-in connector 36 which is integrated with the body 32 for coupling to the wiring harness 24. Each strobe light 22 may additionally include a “U”-shaped bracket 38 connected to the body 32 which subsequently connects to a respective bracket 26, 28. Each strobe light 22 also includes firmware for internally controlling the activation of the LEDs 30. The strobe lights 22 are operably coupled to each other by a wired or wireless connection such that the strobe lights 22 activate in unison, i.e. flash simultaneously. For instance, strobe lights 22 may be connected to each other by a designated synchronization wire, which synchs the activation of the LEDs 30 so that the strobe lights 22 flash in unison. The built-in connector 36 may be fixedly attached to or monolithically formed with the body 32. The built-in connector 36 may be in the form of a female AMP 4P connector which couples with a male connector of the wiring harness 24. Hence, the built-in connector 36 eliminates the need for a pigtail electrical connection. As can be appreciated, the built-in connector 36 may provide multiple lines, such as a power line, a ground line, a synchronization line, and an open line.

The wiring harness 24 connects the lighting devices 22 the electrical power source 16 of the work vehicle 10. Also, the wiring harness 24 connects the lighting devices 22 to each other. The wiring harness 24 may be in the form of one or more wires. The wiring harness 24 is located underneath the top of the roof 18. For example, the wiring harness 24 may be located above the roof 18 and below the roof cap portion. The wiring harness 24 may or may not be positioned within designated grooves, ribs, or channels within the roof 18 and/or roof cap portion. In this regard, the roof 18 and/or roof cap portion substantially, e.g. completely, covers and protects the wiring harness 24 from contacting external objects.

The brackets 26, 28 mount each lighting device 22 to the roof 18 (FIG. 3). The warning light system 20 may include two, four, or more brackets 26, 28 for mounting the lighting devices 22. For example, the warning light system 20 may include two extension brackets 26 and four flat brackets 28. The extension brackets 26 can mount the front lighting devices 22 to the flat brackets 28 which are connected to the roof 18. The extension brackets 26 lower the front lighting devices 22 in order to avoid any contact or interference with various other features, e.g. front lights (unnumbered). The two rear flat brackets 28 can mount the rear lighting devices 22 directly to the roof 18. Thereby, the front lighting devices 22 are positioned lower than the rear lighting devices 22 (FIG. 2). It should be appreciated that the extension brackets 26 may directly mount the front lighting devices 22 to the roof without intermediary flat brackets 28. The brackets 26, 28 may comprise any desired shape and any desired material. As can be appreciated, the brackets 26, 28 may be configured as the same brackets such that the front and rear lighting devices 22 are level with one another.

The operator may control the activation of the lighting devices 22 within the cab 14. For instance, the cab 14 may include a user interface, such as a side console with an integrated key pad warning-light switch, which allows the user to turn the lighting devices 22 on or off as desired. Additionally and/or alternatively, the electrical processing circuit of the work vehicle 10 may automatically control the operation of the warning light system 20.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. A warning light system for a work vehicle, the work vehicle comprising a cab and an electrical power source, the cab comprising a roof with a top surface defining a plane, the warning light system comprising:
a plurality of lighting devices configured for being connected to the roof and located underneath the plane of the top surface of the roof, and at least two lighting devices of the plurality of lighting devices are configured for being visible at any side of the work vehicle; and
a wiring harness configured for operably connecting the plurality of lighting devices to the electrical power source.

2. The warning light system of claim 1, wherein each light of the plurality of lights are configured for being permanently and unmovably connected to the roof.

3. The warning light system of claim 1, wherein the roof comprises four corners, and the plurality of lighting devices comprises four lighting devices which are configured for being respectively located adjacent to each corner of the roof.

4. The warning light system of claim 3, wherein each lighting device being located underneath and angled relative to each corner of the roof.

5. The warning light system of claim 1, wherein each lighting device of the plurality of lighting devices is a strobe light comprising an array of light emitting diodes (LEDs).

6. The warning light system of claim 5, wherein the strobe lights are operably coupled to each other such that the strobe lights activate in unison.

7. The warning light system of claim 1, wherein each strobe light comprises a body, a window case connected to the body, and a connector for coupling to the wiring harness.

8. The warning light system of claim 7, wherein the connector is a built-in connector that is integrated with the body.

9. The warning light system of claim 1, further comprising a plurality of brackets configured for connecting each lighting device of the plurality of lighting devices to the roof.

10. The warning light system of claim 1, wherein the roof is configured for covering and protecting the wiring harness.

11. A work vehicle, comprising:
a chassis;
an electrical power source supported by the chassis;
a cab connected to the chassis, the cab comprising a roof with a top surface defining a plane; and
a warning light system comprising a plurality of lighting devices connected to the roof and located underneath the plane of the top surface of the roof, and at least two lighting devices of the plurality of lighting devices are configured for being visible at any side of the work vehicle, and a wiring harness for operably connecting the plurality of lighting devices to the electrical power source.

12. The work vehicle of claim 11, wherein each light of the plurality of lights are permanently and unmovably connected to the roof.

13. The work vehicle of claim 11, wherein the roof comprises four corners, and the plurality of lighting devices comprises four lighting devices which are respectively located adjacent to each corner of the roof.

14. The work vehicle of claim 13, wherein each lighting device is located underneath and angled relative to each corner of the roof.

15. The work vehicle of claim 11, wherein each lighting device of the plurality of lighting devices is a strobe light comprising an array of light emitting diodes (LEDs).

16. The work vehicle of claim 15, wherein the strobe lights are operably coupled to each other such that the strobe lights activate in unison.

17. The work vehicle of claim 11, wherein each strobe light comprises a body, a window case connected to the body, and a connector for coupling to the wiring harness.

18. The work vehicle of claim 17, wherein the connector is a built-in connector that is integrated with the body.

19. The work vehicle of claim 11, wherein the warning light system further comprises a plurality of brackets connecting each lighting device of the plurality of lighting devices to the roof.

20. The work vehicle of claim 11, wherein the roof covers and protects the wiring harness.
